(19) United States
(12) Patent Application Publication
(10) Pub. No.: US 2013/0019181 A1
(43) Pub. Date: Jan. 17, 2013

(54) ENSURING VARIETY IN A FEED

(71) Applicants: Sage Kitamorn, Seattle, WA (US); Sreeharsha Kamireddy, Seattle, WA (US); Yi Lang Mok, Bellevue, WA (US)

(72) Inventors: Sage Kitamorn, Seattle, WA (US); Sreeharsha Kamireddy, Seattle, WA (US); Yi Lang Mok, Bellevue, WA (US)

(73) Assignee: MICROSOFT CORPORATION, Redmond, WA (US)

(21) Appl. No.: 13/183,430

(22) Filed: Jul. 15, 2011

(51) Int. Cl. G06F 15/177

(52) U.S. Cl. 715/736

(57) ABSTRACT

The disclosed architecture provides one or more techniques for selecting social contacts and selecting queries in order to populate the visible space of an activity feed (e.g., social search). A technique is provided that prioritizes selection of social contacts for display in a social search activity feed. Another technique is provided that selects queries for display in the social search activity feed. The architecture also provides visual presentation of the social search activity feed information. These techniques ensure an interesting variety of contributors and content while maintaining a time-ordered presentation paradigm.

### BACKGROUND

A basic activity feed can present information from multiple users in a time-ordered manner. However, this presentation can include the following limitations: visible display space is limited, an abundance of users can overwhelm the available display space, an abundance of similar queries can overwhelm the available display space, and prolific users can overwhelm other less active users.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides one or more techniques for selecting social contacts and selecting queries, in order to populate the visible space of an activity feed (e.g., social search). A technique is provided that prioritizes selection of social contacts for display in a social search activity feed. Another technique is provided that selects queries for display in the social search activity feed. The architecture also provides visual presentation of the social search activity feed information. These techniques ensure an interesting variety of contributors and content while maintaining a time-ordered presentation paradigm.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates subcomponents of the selection component.

FIG. 3 illustrates an exemplary rendering of the feed that shows a talkative streak collapsed row.

FIG. 4 illustrates a method in accordance with the disclosed architecture.

FIG. 5 illustrates further aspects of the method of FIG. 4.

FIG. 6 illustrates an alternative method in accordance with the disclosed architecture.

FIG. 7 illustrates further aspects of the method of FIG. 6.

FIG. 8 illustrates a method of prioritized selection of social contacts for display in a social search activity feed.

FIG. 9 illustrates a method of selecting queries for display in a social search activity feed.

FIG. 10 illustrates a method of providing visual presentation of the social search activity feed.

FIG. 11 illustrates a block diagram of a computing system that executes feed processing in accordance with the disclosed architecture.

### DETAILED DESCRIPTION

The disclosed architecture provides one or more techniques for selecting social contacts and selecting queries, in order to populate the visible space of an activity feed (e.g., social search). In a more specific implementation, techniques are disclosed for selecting social contacts and selecting queries in order to populate the visible space of a social search activity feed.

A basic social search activity feed comprises elements that represent a triplet {[Contact] [searched for] [Query]}. The set of potential contacts can be derived from a social network. The set of potential queries can be drawn from a search engine history for these users. These elements are presented in a time ordered list.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

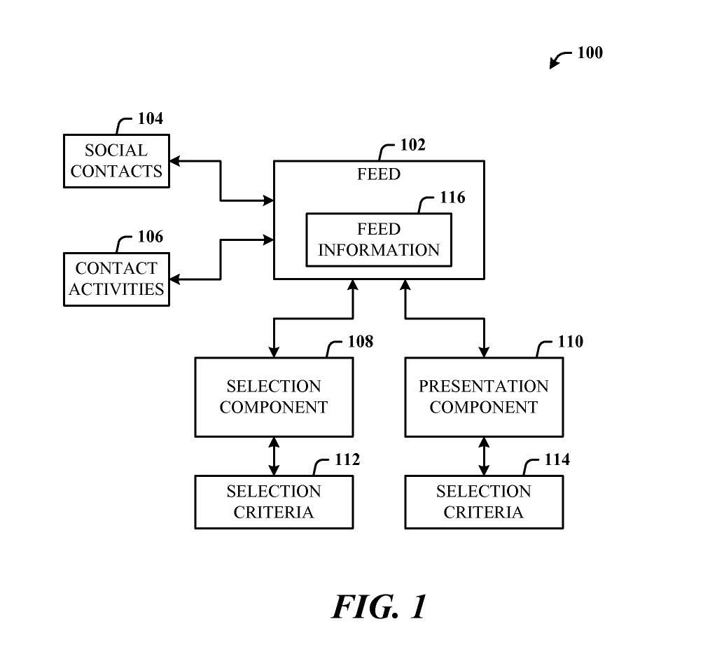

FIG. 1 illustrates a system 100 in accordance with the disclosed architecture. The system 100 includes a feed 102 that receives social contacts 104 and associated contact activities 106. A selection component 108 enables selection of the contacts 104 and associated activities 106 of the feed 102 according to selection criteria 114. A presentation component 110 presents the selected contacts and associated activities according to presentation criteria 114.

The feed 102 can be a social search activity feed, the activities 106 can be queries, and the presentation component 110 can be a browser application that presents feed information 116 in the feed for user interaction (e.g., viewing, selection, etc.). The feed 102 includes feed information 116 as collapsed user rows. The feed 102 can be presented proximate query search results in a webpage. The selection component 108 facilitates prioritized selection and presentation of social contacts in the feed 102. The selection prevents overwhelming of the feed 102 by a group of users.

The selection component 108 facilitates selection of contact activities 106 for presentation in the feed 102. The selection maintains variety of users in the feed 102. The presentation component 110 collapses multiple feed rows of a user into a single user row for presentation as feed information 116 in the feed 102. The presentation component 110 presents a visual indicator in association with the single user row to indicate that the single user row has been collapsed and a link in association with the single user row that when selected exposes search activity hidden from view. The selection component 108 utilizes search histories of users to compute a last activity of a ranked set of the social contacts. The social contacts can be selected based on the last activity. The selection component 108 limits a number of queries per user that are presented in the feed 102.

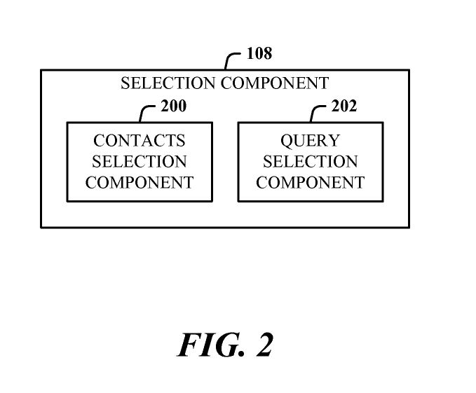

FIG. 2 illustrates subcomponents of the selection component 108. The selection component 108 can include a contacts selection component 200 that facilitates prioritized selection and presentation of social contacts in the feed. The selection component 108 can also include a query selection component 202 that facilitates selection of contact activities for presentation in the feed. These can be separate algorithms employed for the corresponding function.

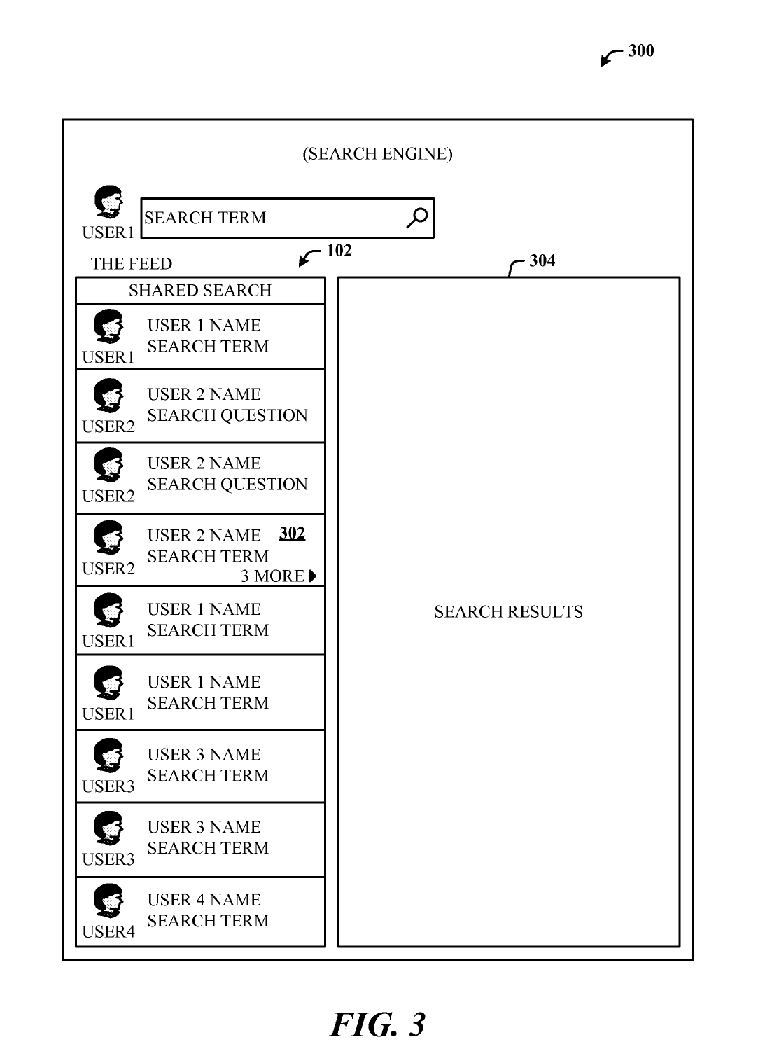

FIG. 3 illustrates an exemplary rendering 300 of the feed 102 that shows a talkative streak collapsed row 302. The collapsed row 302 includes at least the capability (e.g., the “3 MORE” active indicator) to not only indicate the number of collapsed rows, but also to enable expansion of the row 302 to view all the collapsed rows. The feed 102 is presented proximate search results 304.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

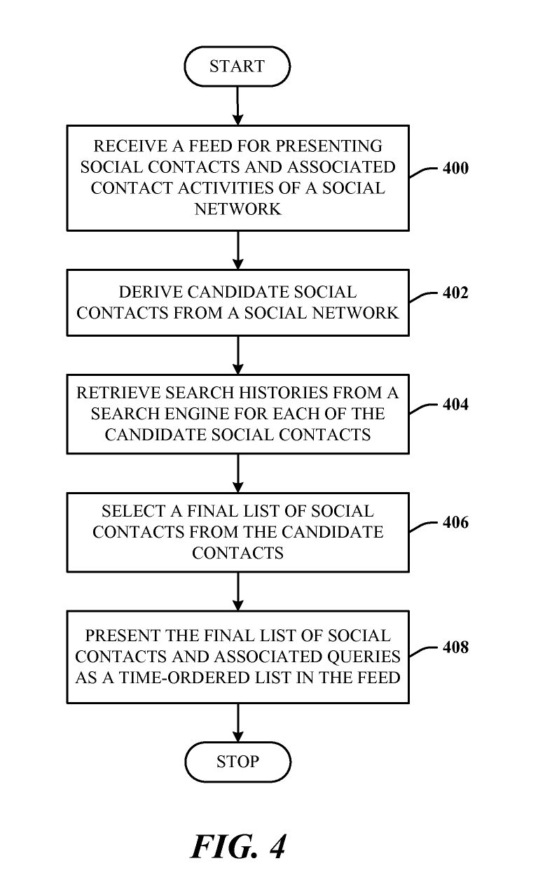

FIG. 4 illustrates a method in accordance with the disclosed architecture. At 400, a feed is received for presenting social contacts and associated contact activities of a social network. At 402, candidate social contacts are derived from a social network. At 404, search histories are retrieved from a search engine for each of the candidate social contacts. At 406, a final list of social contacts is selected from the candidate contacts. At 408, the final list of social contacts and associated queries are presented as a time-ordered list in the feed.

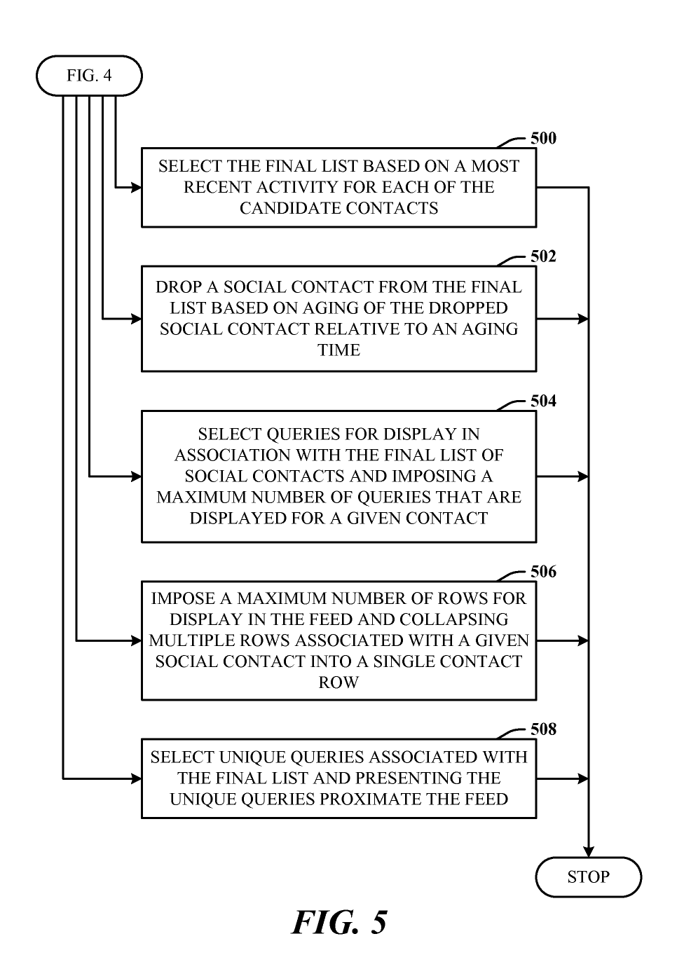

FIG. 5 illustrates further aspects of the method of FIG. 4. Note that the flow indicates that each block can represent a step that can be included, separately or in combination with other blocks, as additional aspects of the method represented by the flow chart of FIG. 4. At 500, the final list is selected based on a most recent activity for each of the candidate contacts. At 502, a social contact is dropped from the final list based on aging of the dropped social contact relative to an aging time. At 504, queries are selected for display in association with the final list of social contacts and a maximum number of queries that are displayed for a given contact is imposed. At 506, a maximum number of rows is imposed for display in the feed and multiple rows associated with a given social contact are collapsed into a single contact row. At 508, unique queries associated with the final list are selected and the selected unique queries are presented in the feed. Associated search results are presented proximate the feed.

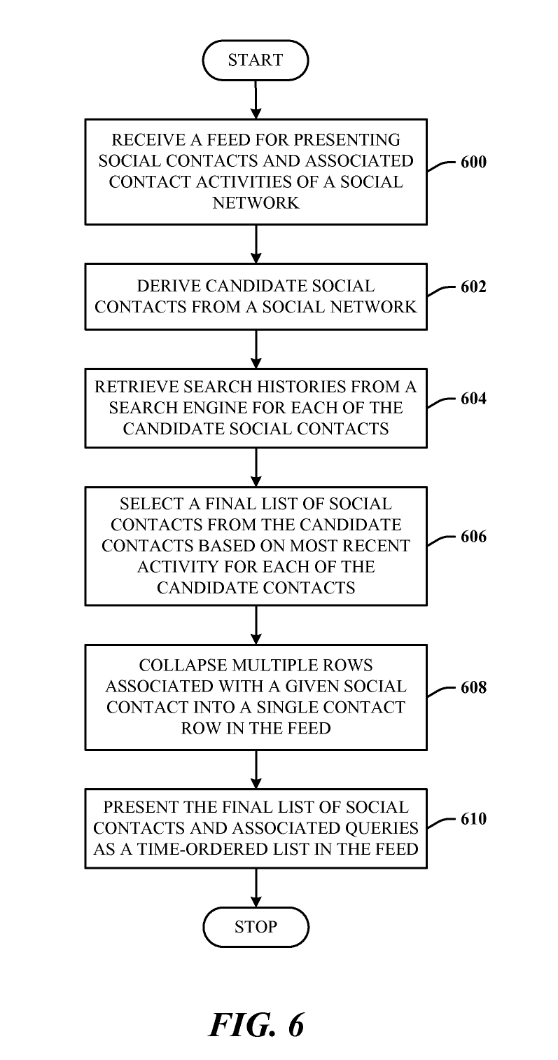

FIG. 6 illustrates an alternative method in accordance with the disclosed architecture. At 600, a feed is received for presenting social contacts and associated contact activities of a social network. At 602, candidate social contacts are derived from a social network. At 604, search histories are retrieved from a search engine for each of the candidate social contacts. At 606, a final list of social contacts is selected from the candidate contacts based on most recent activity for each of the candidate contacts. At 608, multiple rows associated with a given social contact are collapsed into a single contact row in the feed. At 610, the final list of social contacts and associated queries are presented as a time-ordered list in the feed.

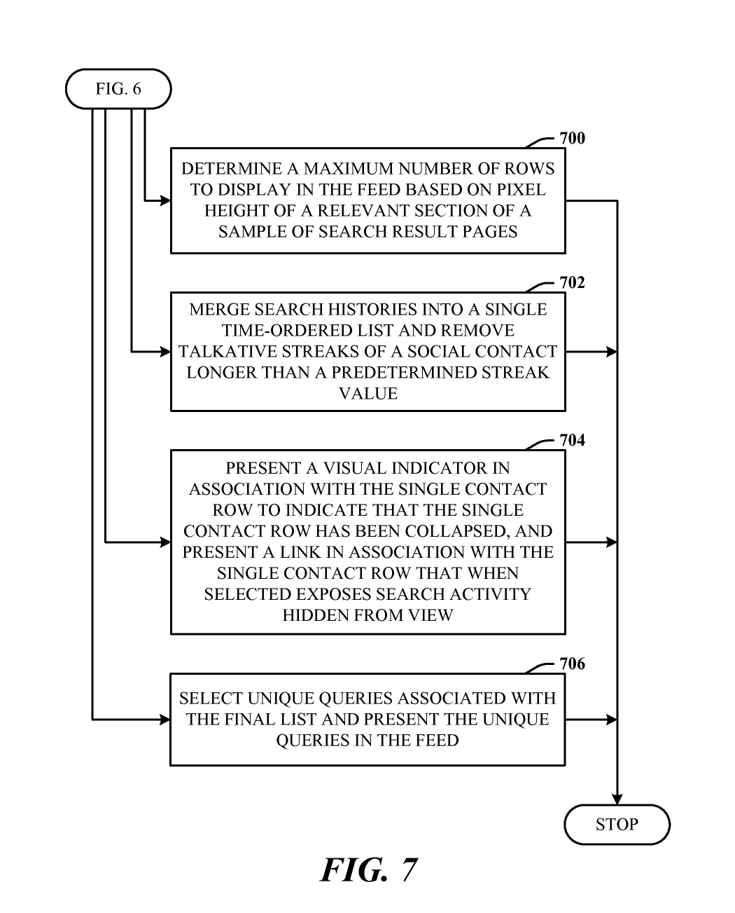

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, a maximum number of rows to display in the feed is determined based on pixel height of a relevant section of a sample of search result pages. At 702, the search histories are merged into a single time-ordered list and talkative streaks of a social contact longer than a predetermined streak value are removed. At 704, a visual indicator is presented in association with the single contact row to indicate that the single contact row has been collapsed, and a link is presented in association with the single contact row that when selected exposes search activity hidden from view. At 706, unique queries associated with the final list are selected and the unique queries are presented in the feed.

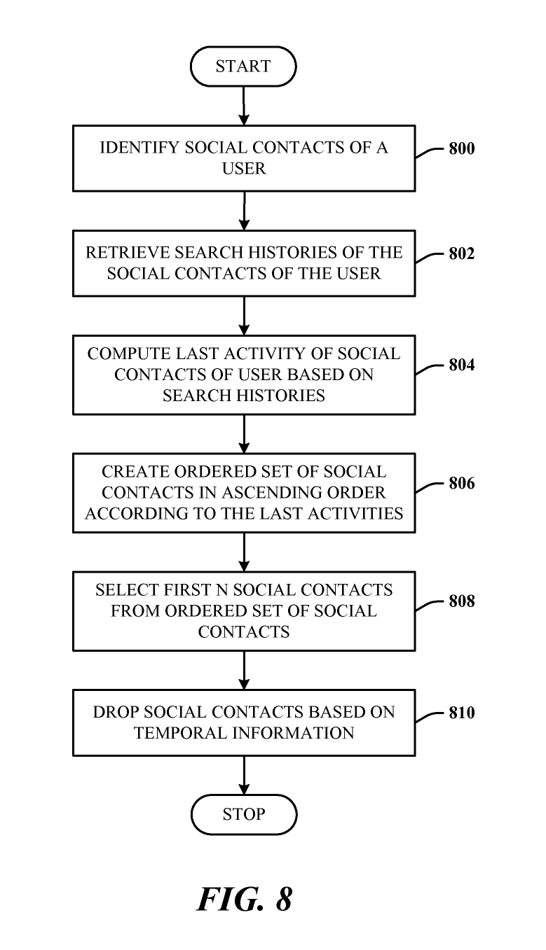

FIG. 8 illustrates a method of prioritized selection of social contacts for display in a social search activity feed. At 800, social contacts of a user are identified. At 802, search histories of the social contacts of the user are retrieved. At 804, a last activity (LA) of the social contacts of the user is computed based on the user search histories. For every user, LA=current time−time of the user's last activity.

At 806, an ordered set of the social contacts is created in ascending order according to the last activities. At 808, a first N of the social contacts is selected from the ordered set of social contacts, where N is a configurable number. At 810, social contacts are dropped based on temporal information. If the last activity of any social contact from N is greater than E, where E is configurable, the social contact is dropped from N. This is performed in order to not have the same old queries in the feed from this social contact.

For example, consider that N includes social contacts H, J, K, L, and M. If social contact M has not issued a query since time E (e.g., one week), this social contact, though in the latest set of social contacts, does not add value, considering that contact M activity is old. This method prevents an abundance of users from overwhelming the feed, while maintaining variety.

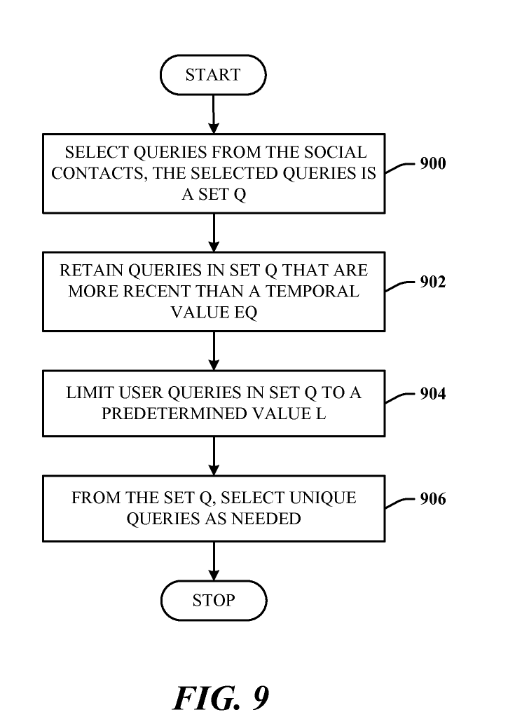

FIG. 9 illustrates a method of selecting queries for display in a social search activity feed. The previous technique can be used to prevent an abundance of users from overwhelming the feed; however, this can still not provide variety in the feed. The variety in the feed can be improved by the following method. All queries are selected from the contacts. The selected queries are referred to as set Q. If a query is more recent than EQ, where EQ is configurable, then the query remains in the set Q (and if not more recent than EQ, the query is discarded). This prevents old queries from becoming part of the set Q, hence, keeping the feed recent and active.

To prevent prolific users from overwhelming the thread, each user's queries in the set Q can be limited to L (e.g., L=15, such that the set Q can contain a maximum of fifteen queries from a unique user). L is configurable. From the set Q, unique queries are selected, as needed, thereby enabling the prevention of a single query to overwhelm the feed. Uniqueness can be determined by comparing the text of the query. Through the above method, a variety of queries is maintained in the feed without letting prolific user's queries overwhelm the feed.

In other words, at 900, queries are selected from the social contacts, the selected queries is a set Q. At 902, queries more recent than a temporal value EQ are retained in the set Q. At 904, user queries in set Q are limited to a predetermined value L. At 906, from the set Q, unique queries are selected as needed.

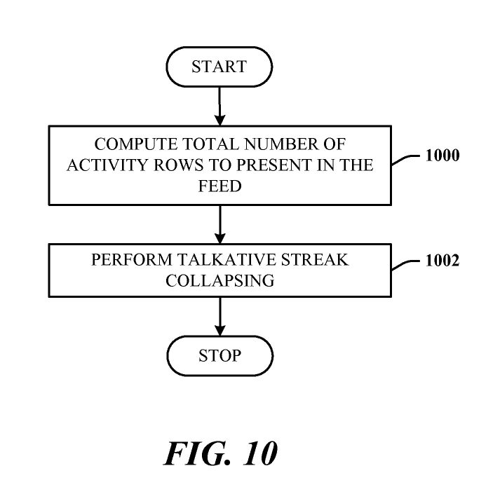

FIG. 10 illustrates a method of providing visual presentation of the social search activity feed. The method begins with selection of a total number of activity rows to display. The initial display of the social search activity feed is bounded by the number of rows, R. R is chosen to optimize for attractive display of a social search activity feed when placed adjacent to a set of search results (e.g., in a web page). An appropriate number for the value R can be determined by measuring the height in pixels of the relevant section of a representative sample of search results pages.

The following formula can be used to compute the rows R.

R={[Average height of search results]−[Height of spacing and other fixed values]}/[Height of one feed row]

Based on these calculations, an initial value of R=15 can be chosen. R is a configurable parameter, and can be changed based on future considerations.

With respect to talkative streak collapsing, analysis of patterns of search behavior indicates that user searches tend to be clustered in sessions, with relatively large gaps of time between sessions. When merging multiple users search query histories into a single time-ordered list, the visual presentation is characterized by “talkative streaks” (a high number of searches in a short period of time) by individual users. As the length of a talkative streak approaches a value R (where R is a positive integer), the variety of contributors represented in the feed needs to be reduced since activity from one or more prolific user pushes out activity from other users.

Accordingly, a talkative streak collapsing method is employed, as follows. Prior to displaying the social search activity feed to the user, the uncollapsed social search activity feed data is sorted in time order. Select a value S (where S is a positive integer) to represent the maximum allowable consecutive feed rows by one user. The value S is a configurable parameter (e.g., S=3). Starting with the most recent entry, the social search activity feed is parsed one entry at a time. A counter of the number of consecutive queries which are found from the same user is maintained. Any time a new user is encountered during this scan, the counter is reset to zero.

If a consecutive sequence of queries larger than the value S is found from the same user, the total length of the consecutive sequence is counted and designated as the value T. The number of surplus queries U, where U=T−S, is calculated and stored. The oldest U queries of this sequence are labeled as not to be displayed. A marker is then inserted to indicate U queries were collapsed at this spot. All talkative streaks longer than S are then removed from the feed.

Upon display of the feed to the user, a visual indicator and link are presented at each marked spot to signify that rows have been collapsed and to provide a means to view the search activity that was hidden from view.

More generally, at 1000, the total number of activity rows to present in the feed is computed. At 1002, talkative streak collapsing is performed.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

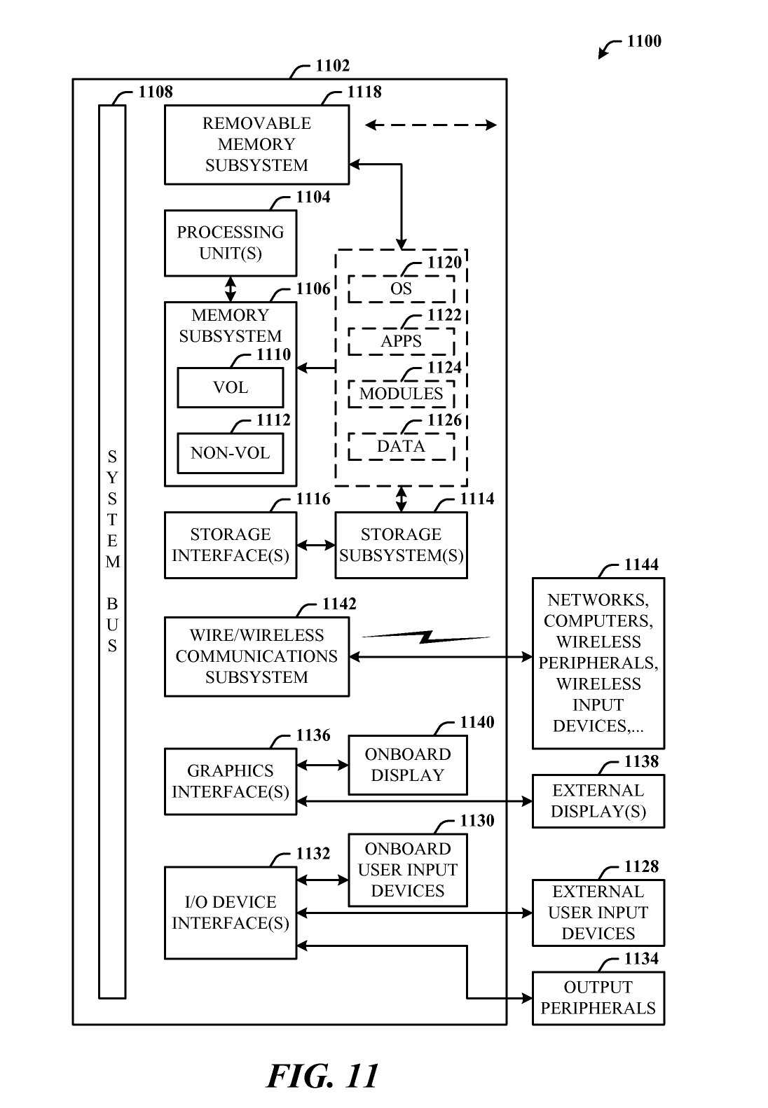

Referring now to FIG. 11, there is illustrated a block diagram of a computing system 1100 that executes feed processing in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a computer-readable storage such as a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include computer-readable storage (physical storage media) such as a volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components. The storage subsystem(s) 1114 (physical storage media) can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include the entities and components of the system 100 of FIG. 1, the subcomponents of the system 200 of FIG. 2, the rendering 300 of FIG. 3, and the methods represented by the flowcharts of FIGS. 4-10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1102 and includes volatile and non-volatile internal and/or external media that is removable or non-removable. For the computer 1102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
a feed that receives social contacts and associated contact activities;
a selection component that enables selection of the contacts and associated activities of the feed according to selection criteria;
a presentation component that presents the selected contacts and associated activities according to presentation criteria; and
a processor that executes computer-executable instructions associated with at least one of the feed, selection component, or presentation component.

2. The system of claim 1, wherein the feed is a social search activity feed, the activities are queries, and the presentation component is a browser that presents feed information for user interaction.

3. The system of claim 2, wherein the feed includes collapsed user rows, the feed presented proximate query search results in a webpage.

4. The system of claim 1, wherein the selection component facilitates prioritized selection and presentation of social contacts in the feed, the selection prevents overwhelming of the feed by a group of users.

5. The system of claim 1, wherein the selection component facilitates selection of contact activities for presentation in the feed, the selection maintains variety of users in the feed.

6. The system of claim 1, wherein the presentation component collapses multiple feed rows of a user into a single user row for presentation in the feed.

7. The system of claim 6, wherein the presentation component presents a visual indicator in association with the single user row to indicate that the single user row has been collapsed, and a link in association with the single user row that when selected exposes search activity hidden from view.

8. The system of claim 1, wherein the selection component utilizes search histories of users to compute a last activity of a ranked set of the social contacts, the social contacts selected based on the last activity.

9. The system of claim 1, wherein the selection component limits a number of queries per user that are presented in the feed.

10. A computer-implemented method, comprising acts of:
receiving a feed for presenting social contacts and associated contact activities of a social network;
deriving candidate social contacts from a social network;
retrieving search histories from a search engine for each of the candidate social contacts;
selecting a final list of social contacts from the candidate contacts;
presenting the final list of social contacts and associated queries as a time-ordered list in the feed; and
utilizing a processor that executes instructions stored in memory to perform at least one of the acts of deriving, retrieving, or presenting.

11. The method of claim 10, further comprising selecting the final list based on a most recent activity for each of the candidate contacts.

12. The method of claim 10, further comprising dropping a social contact from the final list based on aging of the dropped social contact relative to an aging time.

13. The method of claim 10, further comprising selecting queries for display in association with the final list of social contacts and imposing a maximum number of queries that are displayed for a given contact.

14. The method of claim 10, further comprising imposing a maximum number of rows for display in the feed and collapsing multiple rows associated with a given social contact into a single contact row.

15. The method of claim 10, further comprising selecting unique queries associated with the final list and presenting the unique queries in the feed.

16. A computer-implemented method, comprising acts of:
receiving a feed for presenting social contacts and associated contact activities of a social network;
deriving candidate social contacts from a social network;
retrieving search histories from a search engine for each of the candidate social contacts;
selecting a final list of social contacts from the candidate contacts based on most recent activity for each of the candidate contacts;
collapsing multiple rows associated with a given social contact into a single contact row in the feed;
presenting the final list of social contacts and associated queries as a time-ordered list in the feed; and
utilizing a processor that executes instructions stored in memory to perform at least one of the acts of deriving, retrieving, selecting, collapsing, or presenting.

17. The method of claim 16, further comprising determining a maximum number of rows to display in the feed based on pixel height of a relevant section of a sample of search result pages.

18. The method of claim 16, further comprising merging the search histories into a single time-ordered list and removing talkative streaks of a social contact longer than a predetermined streak value.

19. The method of claim 16, further comprising presenting a visual indicator in association with the single contact row to indicate that the single contact row has been collapsed, and presenting a link in association with the single contact row that when selected exposes search activity hidden from view.

20. The method of claim 16, further comprising selecting unique queries associated with the final list and presenting the unique queries in the feed.
